(19) United States
(12) Patent Application Publication
(10) Pub. No.: US 2026/0145813 A1
(43) Pub. Date: May 28, 2026

(54) REAL TIME MEMORY OVERRIDE EMULATOR AND METHOD

(71) Applicant: ROCKWELL COLLINS, INC., Cedar Rapids, IA (US)

(72) Inventor: Andrew K. JEFFREY, Anamosa, IA (US)

(73) Assignee: ROCKWELL COLLINS, INC., Cedar Rapids, IA (US)

(21) Appl. No.: 18/960,515

(22) Filed: Nov. 26, 2024

(51) Int. Cl. B64F 5/60; B64D 45/00

(52) U.S. Cl. CPC B64F 5/60; B64D 45/00; B64D 2045/0065

(57) ABSTRACT

A networking emulator for an aircraft provides performance check data and aircraft data to a selected line replacement unit (LRU) of an aircraft. An Ethernet I/O buffer coupled to receive performance check data. A Peek/Poke I/O buffer receives the performance check data. A Peek/Poke processor coupled to the Peek/Poke I/O buffer, is operative to apply memory commands to an I/O buffer of the selected LRU. An Aircraft Flows I/O buffer receives external aircraft data. A Switch I/O Buffer is coupled to the Peek/Poke processor and to the Aircraft Flows I/O Buffer. A Switch processor, coupled to the switch I/O buffer, determines when performance check data and aircraft data should be applied to the selected LRU.

### FIELD OF THE INVENTION

The subject matter disclosed herein relates to avionics and, in particular, to equipment for designing, testing and debugging such software for avionics.

### BACKGROUND OF THE INVENTION

Airborne electronic equipment or other avionics equipment can be implemented aboard aircraft in a packaging style referred to as Line Replaceable Units (“LRUs”). The term “LRU” refers to a black box of electronics, such as a radio or other auxiliary equipment for a complex engineered system like an airplane or a ship. LRUs speed up installation and repair because they can be installed and replaced quickly. Typically, LRUs also reduce the cost and increase the quality of systems by spreading development costs of the type of unit over different models of vehicles. LRUs are typically mounted in aircraft equipment racks. Although these equipment racks vary in size and construction, depending upon the aircraft, the racks uniformly provide the means to house the LRUs and secure the LRUs to the aircraft.

Test stations incorporating actual avionics equipment are generally expensive and must be shared among the entire software development team. For large systems employing many engineers, this often results in a bottleneck, since parallel development is limited by the hardware resources available.

Consequently, there exists a need for improvement in the testing of avionics software.□

### SUMMARY OF THE INVENTION

The present disclosure is directed, in a first aspect, to a networking emulator for an aircraft an Ethernet I/O buffer an Ethernet I/O buffer coupled to receive performance check data corresponding to a selected line replacement units (LRU) of the aircraft. A Peek/Poke Block is coupled to the Ethernet I/O buffer and operative to receive the performance check data. The Peek/Poke Block includes a Peek/Poke I/O buffer coupled to the Ethernet I/O buffer and a Peek/Poke processor coupled to the Peek/Poke I/O buffer. The Peek/Poke processor is operative to apply memory commands to an I/O buffer of the selected LRU. An Aircraft Flows I/O buffer is operative to receive external aircraft data. A Switch I/O Buffer is coupled to the Peek/Poke Block and to the Aircraft Flows I/O Buffer. A Switch processor is coupled to the Switch I/O buffer and is operative to determine when performance check data and external aircraft data should be applied to the selected LRU.

In yet another embodiment, the present disclosure is directed to a test station for avionics of an aircraft comprising a networking emulator coupled to receive performance check data and to receive aircraft data and at least one line replacement unit coupled to the networking emulator.

In yet another embodiment, the present disclosure is directed to a method for testing avionics of an aircraft. In one step, performance check data corresponding to a selected line replacement units (LRU) of the aircraft is received. Next, for the performance check data, memory commands to apply to an I/O buffer of the selected LRU are determined. Next, external aircraft data is received. Next, for the external aircraft data, aircraft commands to apply to the I/O buffer of the selected LRU are determined. Next, one of the memory commands and aircraft commands is applied to the selected LRU.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 illustrates an embodiment of the networking emulator 10.

FIG. 2 illustrates the avionics equipment of an aircraft in the LRU packaging style.

FIG. 3 illustrates LRUs shown in FIG. 2, have been modelled physically and functionally in at least one multi-function processor.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art. It is to be understood that all concentrations disclosed herein are by weight percent (wt. %.) based on a total weight of the composition unless otherwise indicated.

The present disclosure is directed to a software driven emulation system for aircraft avionics comprising a networking emulator. An external multi-function microprocessor applies the networking emulator to LRUS simulate the functionality of a system of avionics that controls an aircraft.

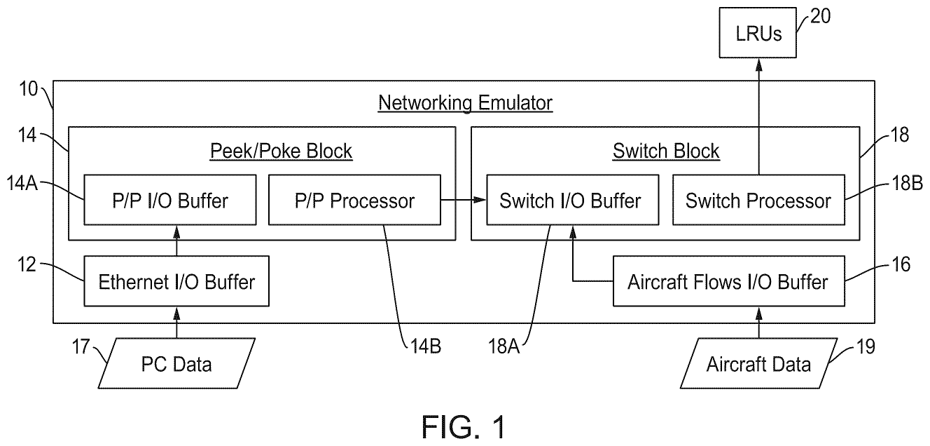

FIG. 1 illustrates an embodiment of the networking emulator 10. An Ethernet I/O buffer 12 is coupled to receive external performance check data 17 from a personal computer (not shown). The performance check data is a process that ensures that avionics test equipment is functioning properly and within specifications. In this embodiment, the performance check data includes but are not limited to test performance, debug, and full flight simulation.

A Peek/Poke block 14 is coupled to the Ethernet I/O buffer 12 to receive the performance check data. The Peek/Poke (P/P) Block 14 includes a P/P I/O buffer 14A coupled to a P/P processor 14B. For a LRU under test, the P/P processor 14B applies the Peek command to access a specific memory address and the Poke command to set a specific memory address.

An Aircraft Flows I/O Buffer 16 receives aircraft data 19 from external aircraft data buffers, e.g., ARINC 664, ARINC 429, etc. ARINC 664, also known as Avionics Full-Duplex Switched Ethernet (AFDX), is a data network and avionics communications bus used in modern airplanes. ARINC 429 is an aerospace standard that defines the characteristics of data transference inside aerospace avionic devices typically used in commercial aircraft.

A Switch Block 18 is coupled to the Peek/Poke Block 14 and to the Aircraft Flows I/O Buffer 16. The Switch Block 18 includes a Switch I/O Buffer 18A and a Switch processor 18B. For a LRU under test, the Switch processor 18B determines when the performance check data and aircraft data should be applied to the I/O Buffers of LRUs 20 under test.

The network emulator 10 may be applied to the physical embodiment of the LRUs 20 or to simulation models representing the LRUs 20. Further, the network emulator may be implemented in cores of a multi-function processor or as a microprocessor smart card.

A microprocessor smart chip card contains a central processing unit (CPU) and operating system that performs multiple functions while securing your data, assets, and identity. Smart cards are small and portable, they can interact with computers and other automated systems, and the data they carry can be updated instantaneously. Further, the smart card can provide security authentication for sensitive data.

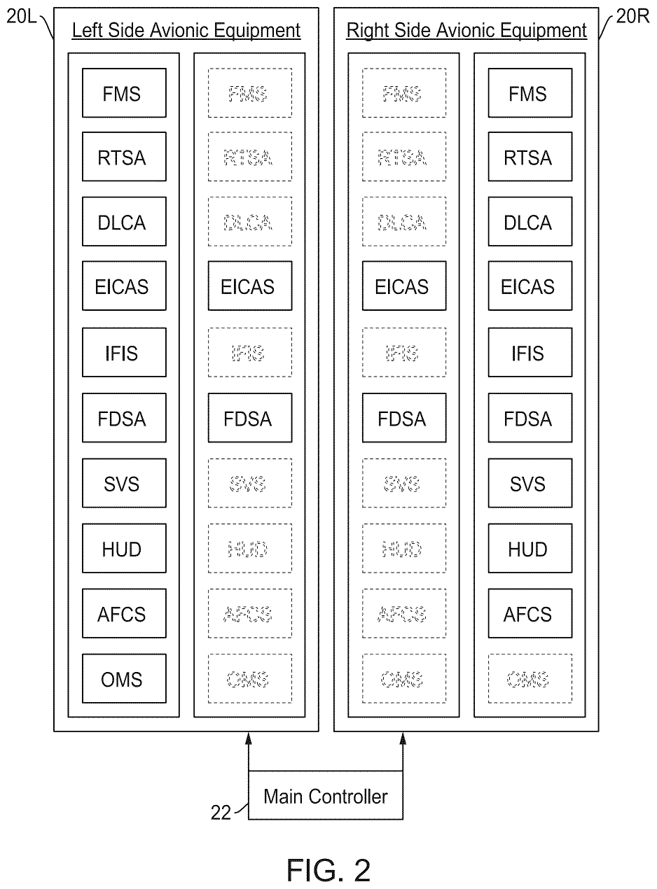

FIG. 2 illustrates the avionics equipment of an aircraft in the LRU packaging style. The typical LRUs include but are not limited to:
FMS (flight management system)
RTSA (radio tuning software application)
DLCA (data link communication application)
EICAS (engine indicating and crew system)
AFCS (automatic flight control system)
FDSA (flight display system application)
SVS (synthetic vision system)
HUD (head up display system)
OMS (on board maintenance system)
IFIS (integrated flight information system)

The avionic equipment is needed for both the right and left side of the aircraft, e.g. right side avionic equipment 20R and left side avionic equipment 20L. Further, a main controller 22 manages the avionics equipment 20R, 20L for both sides of the aircraft. For this system, the network emulator 10 may be used to debug the avionics system in situ.

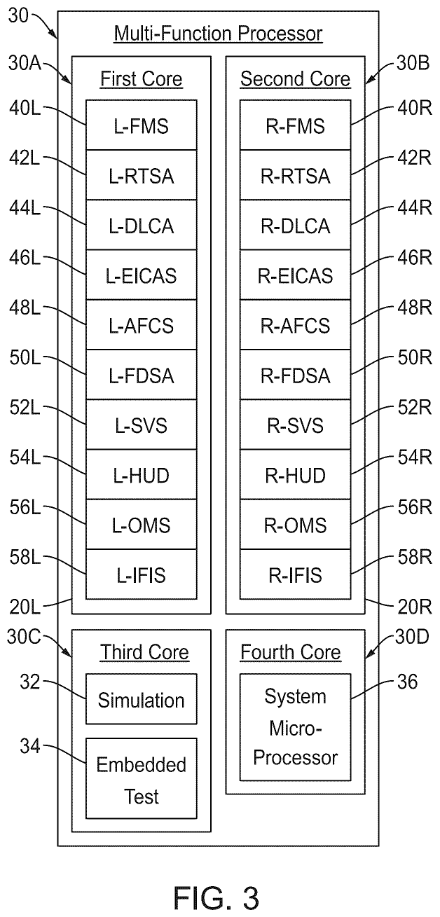

FIG. 3 illustrates LRUs shown in FIG. 2, have been modelled physically and functionally in at least one multi-function processor. Each rack is implemented in a core of a multi-function processor 30. In a first core 12, the Left side Avionic equipment 20L has been modelled and stored in a first core 30A. In a second core 30B, the Right side Avionic equipment 20R has been modelled and stored in two sub cores. A third core 30C includes a model of the simulation function 32 and a model of the embedded test software 34. A fourth core 30D includes the microprocessor 36 that manages the interactions or signals between all the cores. The embodiment may be used independently in-flight simulators when avionics hardware is not available. The modelling of the LRUs physically and functionally enables mixed solutions of hardware and simulation. Similar to the network emulator 10, the LRUs 20R, 20L may be implemented in a smart card. A multiple smart card embodiment allows for a portable aircraft simulator where the type of aircraft can be easily modified with added security. In another embodiment, the network emulator 10 and the modelled LRUs 20R, 20L are implemented in a single smart card.

The first core 30A illustratively includes the processes corresponding to the following avionic equipment for the left side of the aircraft: L-FMS (flight management system) 40L, L-RTSA (radio tuning software application) 42L, L-DLCA (data link communication application) 44L, L-EICAS (engine indicating and crew system) 46L, L-AFCS (automatic flight control system) 48L, L-FDSA (flight display system application) 50L, L-SVS (synthetic vision system) 52L, L-HUD (head up display system) 54L, L-OMS (on board maintenance system) 56L, and L-IFIS (integrated flight information system) 58L.

The second core 30B illustratively includes the processes corresponding to the following avionic equipment for the right side of the aircraft: R-FMS (flight management system) 40R, R-RTSA (radio tuning software application) 42R, R-DLCA (data link communication application) 44R, R-EICAS (engine indicating and crew system) 46R, R-AFCS (automatic flight control system) 48R, R-FDSA (flight display system application) 50R, R-SVS (synthetic vision system) 52R, R-HUD (head up display system) 54R, R-OMS (on board maintenance system) 56R, and R-IFIS (integrated flight information system) 58R.

The fourth core 30D includes the system microprocessor 36 that manages the interactions and signals between all of the cores. The system microprocessor 36 may apply Peek\Poke logic to overwrite standard Avionics Inputs that may be stored in the third core 30C. The microprocessor 36 executes mixed solutions of hardware HW and simulation SIM in the loop.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A networking emulator for an aircraft comprising:
an Ethernet I/O buffer coupled to receive performance check data corresponding to a selected line replacement units (LRU) of the aircraft;
a Peek/Poke Block coupled to the Ethernet I/O buffer, operative to receive the performance check data, the Peek/Poke Block including,
a Peek/Poke I/O buffer coupled to the Ethernet I/O buffer, and
a Peek/Poke processor coupled to the Peek/Poke I/O buffer, operative to apply memory commands to an I/O buffer of the selected LRU;
an Aircraft Flows I/O buffer operative to receive external aircraft data; and
a Switch I/O Buffer coupled to the Peek/Poke Block and to the Aircraft Flows I/O Buffer; and
a Switch processor, coupled to the switch I/O buffer, operative to determine when performance check data and external aircraft data should be applied to the selected LRU.

2. The networking emulator of claim 1 further comprising a smart card containing the Ethernet I/O Buffer, Peek/Poke Block, Aircraft Flows Buffer, Switch I/O Buffer, and Switch processor.

3. The networking emulator of claim 1 wherein the selected line replacement unit is selected from a group consisting of flight management system, radio tuning software application, data link communication application, engine indicating and crew system, automatic flight control system, flight display system application, synthetic vision system, head up display system, automatic flight control system, on board maintenance system, and integrated flight information system.

4. The networking emulator of claim 1, wherein the selected line replacement unit is avionics equipment.

5. The networking emulator of claim 1, wherein the selected line replacement unit is a model stored in a multi-function processor.

6. The networking emulator of claim 1, wherein the external aircraft data is selected from a group of standards consisting of ARINC 664 and ARINC 429.

7. A test station comprising:
a networking emulator coupled to receive performance check data and to receive aircraft data; and
at least one line replacement unit coupled to the networking emulator.

8. The test station of claim 7, the networking emulator comprising:
an Ethernet I/O buffer coupled to receive performance check data corresponding to a first selected line replacement units (LRU) of the aircraft;
a Peek/Poke Block coupled to the Ethernet I/O buffer, operative to receive the performance check data, the Peek/Poke Block including,
a Peek/Poke I/O buffer coupled to the Ethernet I/O buffer, and
a Peek/Poke processor coupled to the Peek/Poke I/O buffer, operative to apply memory commands to an I/O buffer of the selected LRU;
an Aircraft Flows I/O buffer operative to receive external aircraft data;
a Switch I/O Buffer coupled to the Peek/Poke Block and to the Aircraft Flows I/O Buffer; and
a Switch processor, coupled to the switch I/O buffer, operative to determine when performance check data and external aircraft data should be applied to the selected LRU.

9. The test station of claim 8, further comprising a hybrid smart card containing the Ethernet I/O buffer, Peek/Poke Block, Aircraft flows Buffer, Switch I/O Buffer, and Switch processor.

10. The test station of claim 8, wherein the first selected line replacement unit is selected from a group consisting of flight management system, radio tuning software application, data link communication application, engine indicating and crew system, automatic flight control system, flight display system application, synthetic vision system, head up display system, automatic flight control system, on board maintenance system, and integrated flight information system.

11. The test station of claim 7, wherein the first selected line replacement unit is avionics equipment.

12. The test station of claim 7, wherein the first selected line replacement unit is a model stored in a multi-function processor.

13. The test station of claim 12, comprising:
a second selected line replacement unit coupled to the network emulator, wherein the second selected line replacement unit is avionics equipment, and
wherein the networking emulator is coupled to receive performance check data and to receive aircraft data for the first and the second selected replacement unit.

14. The test station of claim 12, further comprising a smart card containing the network emulator.

15. The test station of claim 14, wherein the smart card includes the first selected line replacement unit.

16. A method for testing avionics of an aircraft comprising:
receiving performance check data corresponding to a selected line replacement units (LRU) of the aircraft;
for the performance check data, determining memory commands to apply to an I/O buffer of the selected LRU;
receiving external aircraft data;
for the external aircraft data, determining aircraft commands to apply to the I/O buffer of the selected LRU; and
applying one of the memory commands and aircraft commands to the selected LRU.

17. The method for testing avionics of claim 16, determining the memory commands comprising:
accessing a specific memory address; and
setting a specific memory address.

18. The method for testing avionics of claim 16, wherein the selected line replacement unit is selected from a group consisting of flight management system, radio tuning software application, data link communication application, engine indicating and crew system, automatic flight control system, flight display system application, synthetic vision system, head up display system, automatic flight control system, on board maintenance system, and integrated flight information system.

19. The method for testing avionics of claim 16, wherein the selected line replacement unit is avionics equipment.

20. The method for testing avionics of 16, wherein the selected line replacement unit is model stored in a multi-function processor.
